(19) United States
(12) Patent Application Publication
(10) Pub. No.: US 2003/0111429 A1
(43) Pub. Date: Jun. 19, 2003

(54) Cavitation method and apparatus for deaeration

(76) Inventors: Antonio Filipe Falcao Montalvao, Rio de Janeiro (BR); William Robert Williams, New Fairfield, CT (US); Henrique Armando Langaro Pareja, Rio de Janeiro (BR)

Correspondence Address: PRAXAIR, INC., LAW DEPARTMENT - M1 557, 39 OLD RIDGEBURY ROAD, DANBURY, CT, 06810-5113, US

(21) Appl. No.: 10/014,480

(22) Filed: Dec. 14, 2001

(51) Int. Cl. C02F 1/38

(52) U.S. Cl. 210/787

(57) ABSTRACT

Liquid, especially water, flowing at a first velocity and at a first pressure in a line having a first cross-sectional area, is deaerated by flowing said stream into and through a region in said line having a second cross-sectional area less than said first cross-sectional area, whereupon in said region the velocity of said stream increases, the pressure of said stream decreases, and gas dissolved in said stream evolves from said stream, and recovering said evolved gas separately from said liquid before it redissolves into said liquid.

### FIELD OF THE INVENTION

The present invention relates to the removal of dissolved or absorbed gas, especially air, from water.

### BACKGROUND OF THE INVENTION

In many processes that employ water, it is desirable that the content of dissolved air or oxygen in the water be lower than the content found in the water as it comes in from a municipal feed line, or as it is recovered in a recycle stream from another processing stage. This is especially the case in processes that employ water in the manufacture of beverages. The dissolved air or oxygen contributes to undesired foaming, undesirable degradation of flavor, or interferes with the dissolution of carbon dioxide into the water during the manufacture of carbonated beverages.

The removal of dissolved air or oxygen from the water is referred to herein as “deaeration”.

Deaeration in the soft drink industry typically uses CO₂ (carbon dioxide) as a stripping gas. This has the advantage that any CO₂ that absorbs into the water is simply incorporated into the carbonated product. In order to accomplish the desired stripping, the deaerator needs to be run at low pressure (vacuum or atmosphere). At these conditions, equilibrium favors gas removal, but gas absorption is difficult. This usually means that little CO₂ is absorbed into the water, so CO₂ losses are high, typically 1 volume of gas (STP) per volume of water.

Current deaeration systems use large amounts of gas, heat, vacuum, or a combination thereof to remove air from the water. Typically, current units simply waste high amounts of CO₂ to accomplish the deaeration, or use vacuum pumps and run the deaerator at low pressure. The former is expensive in terms of raw materials (CO₂), and the latter is expensive in terms of energy, maintenance, and equipment.

Thus, there remains a need for a method of achieving deaeration of water, which is more effective than current methods and is more efficient in terms of the deaeration achieved per resources (such as carbon dioxide and equipment volumes) expended.

### BRIEF SUMMARY OF THE INVENTION

One aspect of the present invention is a method for deaerating liquid, especially water, that contains air, oxygen, nitrogen, or other gas dissolved therein, by

(a) providing a stream of said liquid flowing at a first velocity and at a first pressure in a line having a first cross-sectional area,

(b) flowing said stream into and through a pressure reduction region in said line having a second cross-sectional area less than said first cross-sectional area, whereupon in said pressure reduction region the velocity of said stream increases, the pressure of said stream decreases, and gas dissolved in said stream evolves from said stream, and

(c) recovering said evolved gas separately from said liquid before it redissolves into said liquid.

Another aspect of the present invention is apparatus useful for deaerating a liquid having gas dissolved therein, comprising

a conduit for carrying a stream of said liquid, the conduit having a first cross-sectional area and having a region having a second cross-sectional area less than said first cross-sectional area, and

a separatory vessel having an inlet in fluid communication with the outlet of said region.

### BRIEF DESCRIPTION OF THE DRAWINGS

FIG. 1 is a flowsheet of one embodiment of the present invention.

FIG. 2 is a cross-sectional view of the region of lesser cross-sectional area used in the invention.

FIG. 3 is a flowsheet of another embodiment of the present invention.

### DETAILED DESCRIPTION OF THE INVENTION

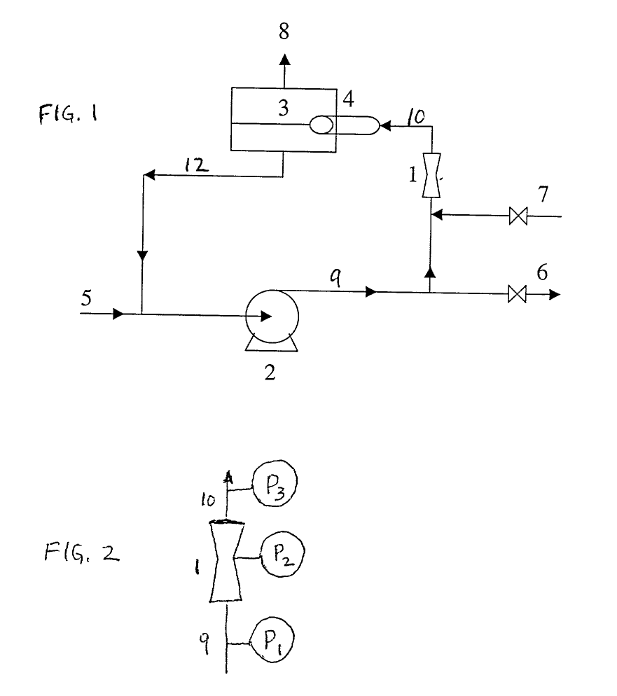

Referring to FIG. 1, which depicts apparatus useful in the practice of the invention, feed water enters as stream 5 and is conveyed to and through pump 2. The stream 9 exiting pump 2 feeds the water to the inlet side of cavitation device 1, at a given first velocity and a given first pressure P₁. The line 9 carrying the water has a given first cross-sectional area. The line is preferably circular in cross-section but can have other profiles.

The cavitation device 1 is characterized in that it has a narrower region 11, seen in FIG. 2, of cross-sectional area less than the cross-sectional area of line 9. Inside the cavitation device 1, the stream of water accelerates in region 11, which causes the pressure of the stream to decrease to a value P2 that is below the bubble point for gas(es) dissolved in the stream. Dissolved gas(es) elute from the liquid.

As the stream exits the cavitation device in stream 10, the liquid pressure will tend to rise again to a level somewhat below the initial pressure P₁ but still above the pressure P₂ in region 11. If no provision is made for this behavior, then because P₃ is greater than the pressure in region 11, the gas(es) will tend to redissolve into the liquid stream. Therefore, the cavitation device 1 is mounted as close as possible to separatory vessel 3 and injection pipe 4 which feeds stream 10 into vessel 3. The vessel 3, and preferably also the injection pipe 4, are designed so that the evolved gas and the deaerated liquid will separate quickly with as little contact area as possible. In this way, gas escapes through the vent 8 in the upper area of vessel 3 before the gas is re-absorbed into the liquid stream.

The stream 12 of deaerated liquid is then recirculated back to the pump. While FIG. 1 depicts that the feed stream 5 is fed before the pump, stream 5 can also be fed after the pump. The size of the pump and the amount of liquid in the recirculation loop will be determined by the desired level of deaeration.

FIG. 1 shows product stream 6, carrying deaerated water, exiting the system downstream from the pump 2 and also downstream from the point at which feed stream 5 enters the system. Alternatively, product stream 6 can be taken off from stream 12, before the point at which feed stream 5 enters the system.

Optionally, a stream 7 of gas, termed “stripping gas” herein, can be added to the water upstream of the cavitation device 1, or at the inlet to that device, to improve deaeration. The added stripping gas elutes from the water upon passage through the region 11 and this gas helps remove the target dissolved gas from the water in region 11 and upon passage and in the separatory vessel 3.

The method of injecting the stripping gas can include the use of other high mass transfer mixing devices to improve the pre-dissolution of the gases. For example, the water is passed through a device such as a gas injector which feeds the gas into the stream. These devices are capable of creating fine gas bubbles for excellent, rapid gas-liquid interfacial mass transfer. The two-phase mixture exiting from this addition stage is still under line pressure. This allows very rapid dissolution of gas into the liquid.

Other types of gas dissolution devices can be used such as the injector disclosed in U.S. Pat. No. 4,743,405. Other inline gas dissolution devices such as supersonic mixers developed by Praxair, Inc. (e.g. U.S. Pat. No. 5,061,406) can be used. These inline gas dissolution devices are preferably chosen for this application because of their ability to create superfine bubbles of gas which are able to dissolve over a short residence time.

The introduction of stripping gas at line 7 assists the deaeration in facilitating the removal of gas from the liquid stream, in region 11 and in vessel 3, consistently with conventional techniques for deaerating by adding a stripping gas. The stripping gas can be preferably air, nitrogen or carbon dioxide. In general, higher flow rates of the injected gas are associated with higher degree of removal of dissolved gas from the water.

Another embodiment of the present invention cycles the water two or more times through the cavitation device, without adding additional feed water or with addition of feed water amounting to no more than 10% of the volume of recycling water. Each passage through region 11 and the separatory vessel removes a high percentage of the dissolved gas still remaining in the water, so that repeated cycles can achieve an overall deaeration on the order of 10²-fold to 10⁵-fold.

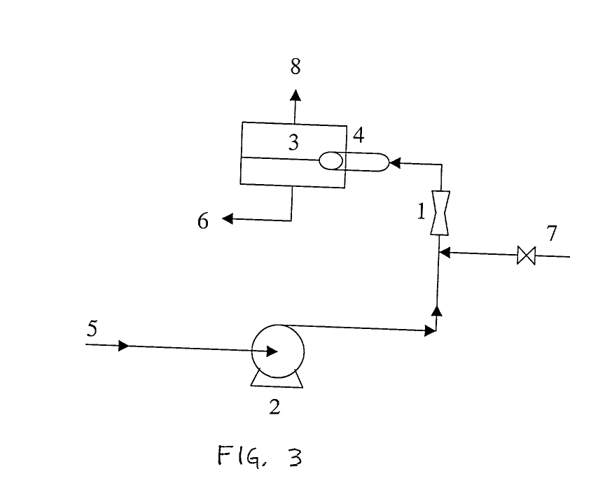

It is also possible to carry out the invention without a recycle stream. Such a single pass system is illustrated in FIG. 3, in which the reference numerals have the same meanings as in FIG. 1. In operation of the single pass embodiment, most of the principles are the same but control for intermittent operation is more difficult.

The method and apparatus of the present invention are more effective and more efficient compared to a typical deaeration system which requires either a vacuum on the vent, heating of the water (thermal systems), or large amounts of gas to strip the air out of the liquid. Of these systems, only thermal deaeration can accomplish deaeration to ppb (parts per billion) levels of deaeration without using multiple stages.

The present invention uses cavitation to create a low-pressure zone in region 11 within the loop. Deaeration occurs in the low-pressure zone, and works like a vacuum system. However, unlike vacuum systems, no vacuum pump is required because the energy is provided in the pump-around loop by the liquid pump and not the vacuum pump. No input of thermal energy, sonic energy, or radiation is employed. Also, all of the mass transfer occurs in the cavitation device, and not in the storage vessel. This is because downstream of the cavitation device, the system returns to a higher pressure where stripped gases will reabsorb. Thus, the vessel only serves as a gas/liquid separator, and mass transfer is minimized.

This is the opposite of traditional systems where the separatory vessel carries out all of the mass transfer. In traditional systems, design of gas/liquid contacting in the vessel is compromised because food quality standards prevent the use of state-of-the-art contacting materials. These high contact area materials also provide high contact for microbiological growth and make cleaning and sanitation difficult. Thus these vessels are poor mass transfer devices.

The system of the present invention is particularly attractive to replace thermal deaerators. Until now, thermal deaeration was the only attractive way to reduce oxygen to low enough levels to meet the more stringent dissolved-gas standards in end-use applications such as the production of beer. Vacuum and gas stripping methods require multiple stages for contacting, which is capital intensive. However, thermal systems are also expensive to build and have high energy costs. The present invention has been shown to deaerate water to even the more stingent standards without heating. This significantly reduces capital and operating costs.

The absolute pressure P₁ is typically 200 kPa to 800 kPa. The absolute pressure P₂ is typically 0 kPa to 30 kPa. The cross-sectional area of region 11 typically is 10% to 50% of the cross-sectional area of line 9 upstream entering the cavitation device.

The present invention provides advantages over other deaeration methods. Devices that use packing materials to enhance liquid-gas contact typically cannot be used to deaerate where the deaerated water is intended to be used in food and beverage applications, because the packing materials have high surface areas and are difficult to clean and sanitize. Therefore, design of these devices must be simple with low contact area, and as a result, they are poor mass transfer devices. Consequently, they must be very large to accomplish the mass transfer, and capital investment in these systems is high.

Further, systems that use injection of CO2 or other gas into the deaerator or the recirculation loop or the water feed have inefficient injection systems. These cause high gas losses without being particularly effective at deaerating. Thus, while the energy use may be lower than the energy use in the cavitating stripper, there are significant costs associated with high losses of the injected gas, which offset any energy savings.

Another significant advantage is in the simplicity of the cavitation system, and the lower energy, equipment and maintenance costs. A typical vacuum system requires a very large tank which is reinforced to withstand the difference in pressure inside and outside the tank, as well as two pumps and all the associated maintenance with the pump. The system of the present invention requires only one pump and a much smaller tank (only enough to separate the gas and liquid) which does not need to be reinforced.

In typical large-scale brewers, beer is brewed in concentrated form and water is added after brewing. This process water typically must be deaerated to remove the oxygen down to a level typically around 0.1 ppm. Otherwise, the oxygen will cause staling of the product.

The preferred method of deaeration in the beer industry is thermal deaeration. This is the only practical way to attain the low oxygen levels. However, it has been discovered that the present invention can easily attain 0.1 ppm oxygen levels, and does so with far lower consumption of energy.

What is claimed is:

1. A method for deaerating liquid, especially water, that contains air, oxygen, nitrogen, or other gas dissolved therein, by
(a) providing a stream of said liquid flowing at a first velocity and at a first pressure in a line having a first cross-sectional area,
(b) flowing said stream into and through a pressure reduction region in said line having a second cross-sectional area less than said first cross-sectional area, whereupon in said region the velocity of said stream increases, the pressure of said stream decreases, and gas dissolved in said stream evolves from said stream, and
(c) recovering said evolved gas separately from said liquid before it redissolves into said liquid.

2. A method according to claim 1 further comprising injecting stripping gas into the stream upstream of said pressure reduction region, and removing said stripping gas from said stream downstream of said pressure reduction region.

3. A method according to claim 2 wherein said the stripping gas is air, nitrogen or carbon dioxide.

4. A method according to claim 1 wherein step (c) comprises feeding said stream into a separatory vessel wherein said evolved gas and said liquid separate from each other, and said evolved gas is vented out of said vessel.

5. A method according to claim 1 wherein after said evolved gas is recovered from said liquid, said liquid is recycled to said line upstream of said region.

6. Apparatus useful for deaerating a liquid having gas dissolved therein, comprising
a conduit for carrying a stream of said liquid, the conduit having a first cross-sectional area and having a region having a second cross-sectional area less than said first cross-sectional area, and
a separatory vessel having an inlet in fluid communication with the outlet of said region.

7. Apparatus according to claim 6 further comprising means to inject gas into said conduit upstream of said region.
